(19) United States
(12) Patent Application Publication
(10) Pub. No.: US 2022/0207288 A1
(43) Pub. Date: Jun. 30, 2022

(54) SELECTING REPRESENTATIVE SCORES FROM CLASSIFIERS

(71) Applicant: International Business Machines Corporation, Armonk, NY (US)

(72) Inventors: Aviad Zlotnick, Mitzpeh Netofah (IL); Flora Gilboa-Solomon, Haifa (IL); Michal Flato, Tel Aviv (IL)

(21) Appl. No.: 17/134,385

(22) Filed: Dec. 26, 2020

(51) Int. Cl. G06K 9/62; G06T 7/00

(52) U.S. Cl. CPC G06K 9/6227; G06T 7/0012; G06K 2209/05; G06K 9/6292; G06K 9/6242; G06K 9/627

(57) ABSTRACT

Aspects of an embodiment of the present invention disclose a method, computer program product, and computing system for selecting representative scores. A processor receives first scores generated by a plurality of object part classifiers classifying a first part of an object. A processor also receives second scores generated by the plurality of object part classifiers classifying a second part of the object. A processor also determines a first aggregation of the first scores. A processor also determines a second aggregation of the second scores. A processor also selects the representative scores from the first scores and the second scores based on a comparison between the first aggregation and the second aggregation.

### BACKGROUND

The present invention relates generally to the field of computer classifier scores, and more particularly to selecting a representative score based on aggregations of scores from object part classifiers.

Classification is a procedure to use a training set of data containing observations with known category membership to identify a category for a new observation. Examples include assigning an email to the “spam” or “non-spam” class, and assigning a diagnosis to a given patient based on observed characteristics of the patient (sex, blood pressure, presence or absence of certain symptoms, etc.).

In the terminology of machine learning, classification is considered an instance of supervised learning, i.e., learning where a training set of correctly identified observations is available. The corresponding unsupervised procedure is known as clustering, and involves grouping data into categories based on some measure of inherent similarity or distance.

Often, the individual observations are analyzed into a set of quantifiable properties, known variously as explanatory variables or features. These properties may variously be categorical, ordinal, integer-valued, or real-valued. Other classifiers work by comparing observations to previous observations by means of a similarity or distance function.

An algorithm that implements classification, especially in a concrete implementation, is known as a classifier. The term “classifier” sometimes also refers to the mathematical function, implemented by a classification algorithm, that maps input data to a category. Computer classification tasks such as object detection and recognition, action recognition, texture classification, data retrieval, tracking, image alignment, among others, are usually performed by object classifiers using global or local properties. In some instances of object classification, results from multiple classifiers may be combined, rather than relying on a single classifier. The combination of classifiers can increase accuracy.

### SUMMARY

Aspects of an embodiment of the present invention disclose a method, computer program product, and computing system for selecting representative scores. A processor receives first scores generated by a plurality of object part classifiers classifying a first part of an object. A processor also receives second scores generated by the plurality of object part classifiers classifying a second part of the object. A processor also determines a first aggregation of the first scores. A processor also determines a second aggregation of the second scores. A processor also selects the representative scores from the first scores and the second scores based on a comparison between the first aggregation and the second aggregation.

### BRIEF DESCRIPTION OF THE DRAWINGS

FIG. 1 depicts a diagram of score selection system in accordance with one embodiment of the present invention;

FIG. 2 depicts a flowchart of the steps of the representative score selection program executing within the system of FIG. 1, in accordance with an embodiment of the present invention;

FIG. 3 depicts a visual representation of information received and determined by the representative score selection program, in accordance with one embodiment of the present invention;

FIG. 4 depicts a visual representation of information received and determined by the representative score selection program, in accordance with one embodiment of the present invention;

FIG. 5 depicts a block diagram of components of one or more of the object server, classifiers, and/or the representative score selection device in accordance with one illustrative embodiment of the present invention.

### DETAILED DESCRIPTION

The disclosed embodiments include devices and methods for selecting representative scores from a plurality of object part classifiers. A plurality of object part classifiers classify an object part with a “score.” The score may include a percentage, a vote (yes/no), or a ranking compared to other object parts, for a likelihood of the object part belonging to one classification or another. Depending on the classification, each object part classifier may classify an object part with a potentially different level of accuracy. Likewise, it is not always clear which classifiers are most accurate, so combinations of classifiers can be used to increase overall accuracy of conclusions drawn from the classification. For example, a consensus of ninety percent of classifiers (that an object belongs in a certain class, or that an object indicates a malignant diagnosis of cancer) can be more conclusive than a score of ninety out of a hundred from a single classifier.

Combining scores from classifiers can be naïve, however, since classifiers often draw conclusions based on different criteria. For instance, in diagnosing cancer in a patient from a plurality of medical images, one classifier may place more emphasis on some of the images, while a different classifier places emphasis on different images. Often there is not even a consensus among classifiers as to which area of the body is most likely to contain cancerous malignancies. The embodiments disclosed herein, therefore, also include aggregations of scores and selecting representative scores that will be utilized in the overall determination of the classifier result.

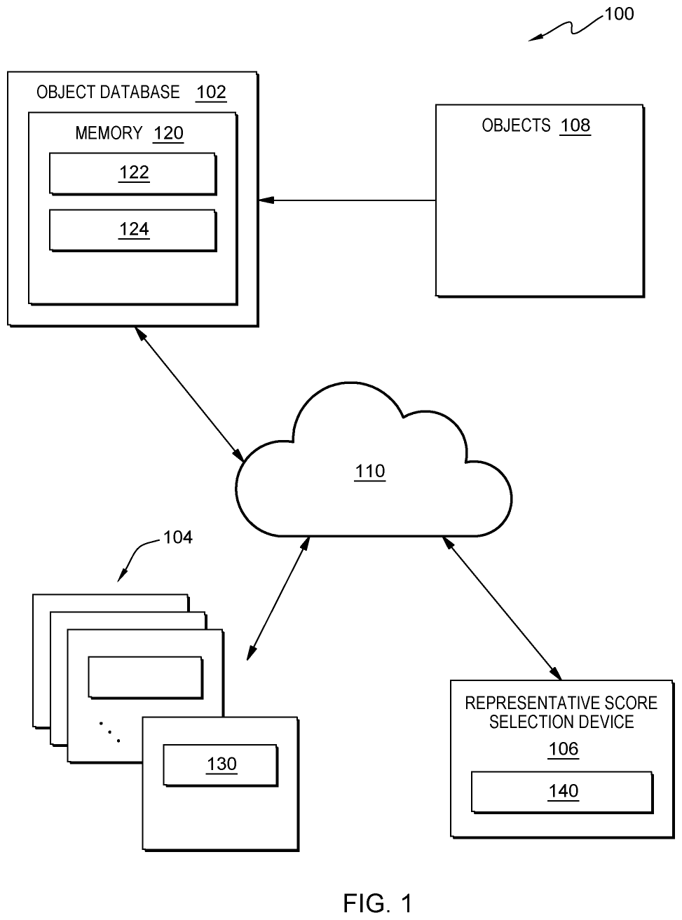

Turning now to the drawings, FIG. 1 depicts a diagram of a score selection system 100 in accordance with one embodiment of the present invention. FIG. 1 provides only an illustration of one embodiment and does not imply any limitations with regard to the environments in which different embodiments may be implemented.

The system 100 includes an object server 102 (e.g., database, filesystem), a plurality of classifiers 104, and a representative score selection device 106. In certain embodiments, as illustrated, the object server 102, the plurality of classifiers 104, and the representative score selection device 106 are communicatively coupled via a communication network 110. The communication network 110 may be a single machine, a local area network (LAN), a wide area network (WAN) such as the Internet, any combination thereof, or any combination of connections and protocols that will support communications between the object server 102, the plurality of classifiers 104, and the representative score selection device 106 in accordance with embodiments of the invention. The communication network 110 may include wired, wireless, or fiber optic connections. In certain embodiments, the object server 102, the plurality of classifiers 104, and the representative score selection device 106 may communicate without requiring the communication network 110, instead communicating via one or more dedicated wire connection or other forms of wired and wireless electronic communication. The system 100 may also include an object parts input device 108. The object parts input device 108 may include measuring devices, imaging equipment, or other data acquisition devices.

The object server 102 includes a memory 120 for storing digital information. The memory 120 may include read-only memory (“ROM”), random access memory (“RAM”) (e.g., dynamic RAM (“DRAM”), synchronous DRAM (“SDRAM”), and the like), electrically erasable programmable read-only memory (“EEPROM”), flash memory, a hard disk, a secure digital (“SD”) card, other suitable memory devices, or a combination thereof. The memory includes, among other potential storage items, object parts 122 that may be viewed, evaluated, or otherwise operated upon by the object server 102, the plurality of classifiers 104, and the representative score selection device 106. For example, the object parts 122 may be accessed, through the communication network 110, by the classifiers 104. The object parts 122 may include any information that may be classified by the classifiers 104. For example, the object parts 122 may include structured and/or unstructured medical or financial records that include measurements of blood components, blood pressure, BMI, age, etc. that could lead to a diagnosis of a disease or other medical condition. The object parts 122 may also include images for medical diagnosis or identification acquired by any image acquisition device. Furthermore, the object parts 122 may include information that may be used by a company to determine insurance rates and eligibility for loans. For example, one object part 122 may include information about a potential customer's belongings, while a different object part 122 includes information about where or what the potential customer studied in school.

The classifiers 104 receive the object parts 122 and perform classification using a variety of classification methods. Any type of classifier 104 may be used within the system 100 without diverging from the embodiments of the present invention. The classifiers 104 generate classifier scores 124 that may be stored on the memory 120 of the object server 102. The classifier scores 124 are generated based on a classifier algorithm 130 that may be a machine-learning algorithm that develops classifications based on labeled object parts fed into the classifier 104. The algorithm 130 then compares the new object parts 122 to the classifications and generates a classifier score 124. The classifiers 104 may include different types of classifiers 104 within the same system 100. For example, one classifier 104 may generate a score for insurance eligibility based on object parts 122 of the data—e.g., one classifier used to determine risk using blood components and another using demographic data.

The classifier score 124 may classify the object parts 122 individually, such that each object part 122 includes a percentage of likelihood that the object part 122 belongs in an affirmative classification, or a yes/no vote for whether the object part 122 belongs in the affirmative classification. The classifier 104 may also evaluate a group of object parts 122 such that the object parts 122 are ranked according to how indicative each object part 122 is of the affirmative classification.

For example, the classifiers 104 may be given object parts 122 that are medical images taken from a patient seeking a diagnosis of the presence of cancer. Each classifier 104 may give each medical image a classifier score 124 signifying a diagnosis of cancer within the image. Since cancer diagnostic imaging is not perfect, none of the classifiers 104 that can be relied upon to give a completely accurate diagnosis in every situation; a combination of the classifier scores 124 is often more accurate. Selecting which classifier scores 124 will be combined, however, is important in determining the best diagnosis. And the system 100 uses the representative score selection device 106 to select the representative scores that will lead to an accurate diagnosis.

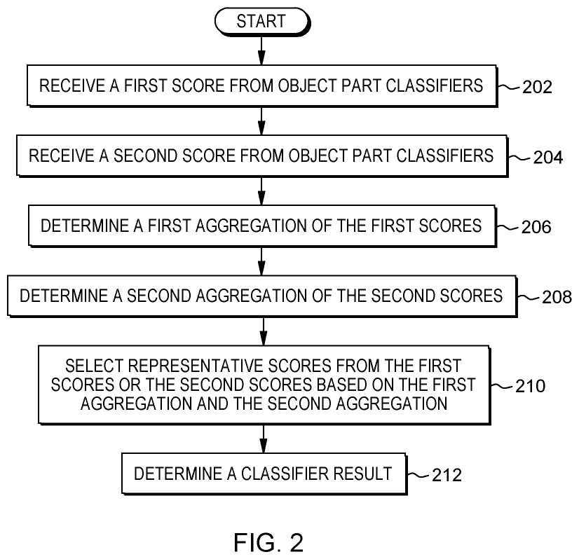

The representative score selection device 106 runs a representative score selection program 132 that can include the method disclosed in FIG. 2. The representative score selection program 132 receives first scores generated by the classifiers 104 (block 202). The first scores may be generated for a first part of an object classified by the classifiers 104. The representative score selection program 132 also receives second scores generated by the classifiers 104 (block 204). The second scores may be generated for a second part of the object.

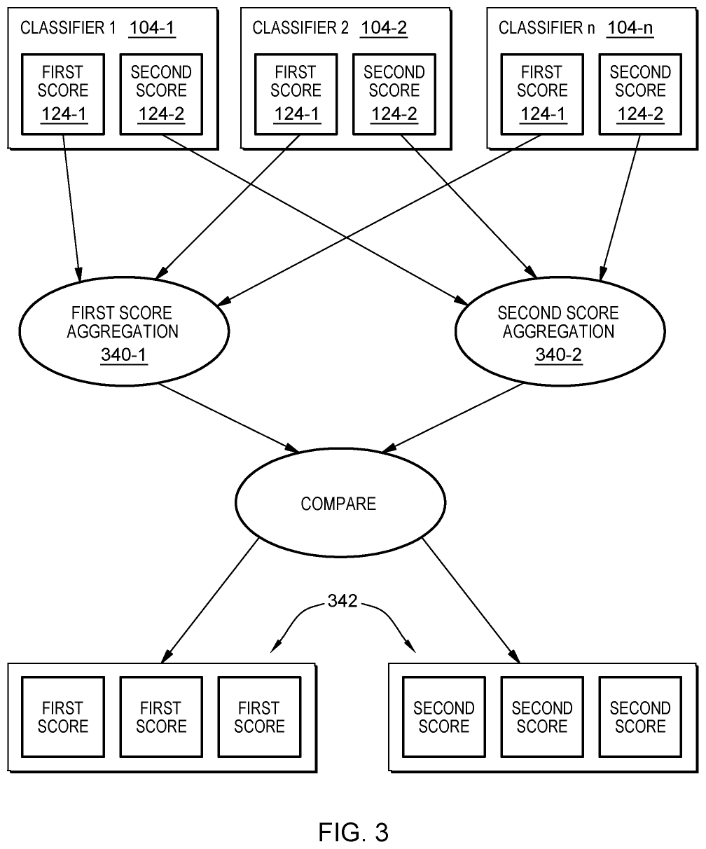

FIG. 3 depicts a visual representation of information received and determined by the representative score selection program 132, in accordance with one embodiment of the present invention. A first classifier 104-1 generates a first classifier score 124-1 and a second classifier score 124-2. A second classifier 104-2 also generates a first classifier score 124-1 and a second classifier score 124-2. The representative score selection program 132 may receive classifier scores 124 from any number of classifiers 104, and this open limit is represented by an nth classifier 104-n that also generates a first classifier score 124-1 and a second classifier score 124-2. In certain embodiments, the first classifier scores 124-1 may include cancer diagnosis scores for a left breast while the second classifier scores 124-2 may include cancer diagnosis scores for a right breast, as given by each of the classifiers 104. The classifier scores 124 may be generated from images captured using digital mammography, magnetic resonance imaging, computed tomography, or digital breast tomosynthesis.

The representative score selection program 132 determines a first aggregation 302 of the first scores 124-1 (block 206), and determines a second aggregation 304 of the second scores 124-2 (block 208). The first aggregation 302 and the second aggregation 304 can be aggregated using a variety of aggregation methods.

In particular, the first aggregation 302 may include aggregations of the first classifier scores 124-1 independent of the second classifier scores 124-2, and the second aggregation 304 may include aggregations of the second classifier scores 124-2 independent of the first classifier scores 124-1. Examples of this type of aggregation include (for the first aggregation 302) summing of all the first classifier scores 124-1, or an average of all the first classifier scores 124-1. Furthermore, the first aggregation 302 may include a number designating how many of the first classifier scores 124-1 is greater than a threshold. The threshold may include, for example, 50 percent, equating the first aggregation 304 to the number of classifiers 104 that vote “Yes” for the classification. The threshold may also be higher, which limits the first aggregation 302 to classifiers that indicate a high degree of certainty for the classification, or lower, which opens the first aggregation 302 to include a greater number of classifiers.

The first aggregation 302 may also include a comparison of the first classifier scores 124-1 with the second classifier scores 124-2, and the converse for the second aggregation 304. For example, the first aggregation 302 may include a percentage of the classifiers 104 for which the first classifier score 124-1 is higher than the second classifier score 124-2, and the second aggregation 304 may conversely include a percentage of the classifiers 104 for which the second classifier score 124-2 is lower than the first classifier score 124-1.

Once the representative score selection program 132 determines the first aggregation 302 and the second aggregation 304, the representative score selection program 132 selects representative scores 306 from the first scores 124-1 or the second scores 124-2 based on a comparison between the first aggregation 302 and the second aggregation 304. Selecting the representative scores 306 may include, for example, selecting a higher value, or a lower value between the first aggregation 302 and the second aggregation 304. The representative score selection program 132 may also select the representative scores 306 by comparing the difference (i.e., between the first aggregation 302 and the second aggregation 304) to a significance gap. That is, the representative score selection program 132 may select a larger aggregation (i.e., between the first aggregation 302 and the second aggregation 304) when the larger aggregation is larger by at least the significance gap, and select a smaller aggregation (i.e., between the first aggregation 302 and the second aggregation 304) when the larger aggregation is larger by less than the significance gap. Taking the significance gap into account enables the representative score selection program 132 to further increase accuracy of classification for some types of objects.

In the embodiment described above where the first classifier scores 124-1 include diagnosis of a left breast, for example, the significance gap may be used to increase accuracy of cancer diagnosis because of the manner in which cancer develops in the majority of cases. That is, the significance gap increases the likelihood of patients with breast cancer being diagnosed with cancer, and patients that do not have breast cancer being diagnosed as not having cancer. Specifically, in patients where cancer is only present in one breast, the classifier scores 124 for the cancer-containing breast are expected to be significantly higher than the classifier scores for the cancer-free breast. Thus, the larger aggregation (i.e., between the first aggregation 302 and the second aggregation 304) will be greater than the smaller aggregation by at least the significance gap, and the classifier scores 124 corresponding to the larger aggregation will be selected as the representative scores 306.

Patients with cancer in neither breast will not show a difference (i.e., between the first aggregation 302 and the second aggregation 304) that is greater than the significance gap, and thus the classifier scores 124 corresponding to the smaller aggregation will be used as the representative scores 306, and will be more likely to lead to a correct diagnosis of no cancer. In patients that have cancer present in both breasts, in which neither aggregation (i.e., between the first aggregation 302 and the second aggregation 304) is larger by the significance gap, the representative score selection program 132 selects the smaller aggregation, which still gives a correct diagnosis because in the majority of cases the smaller score is high enough for a cancer classification.

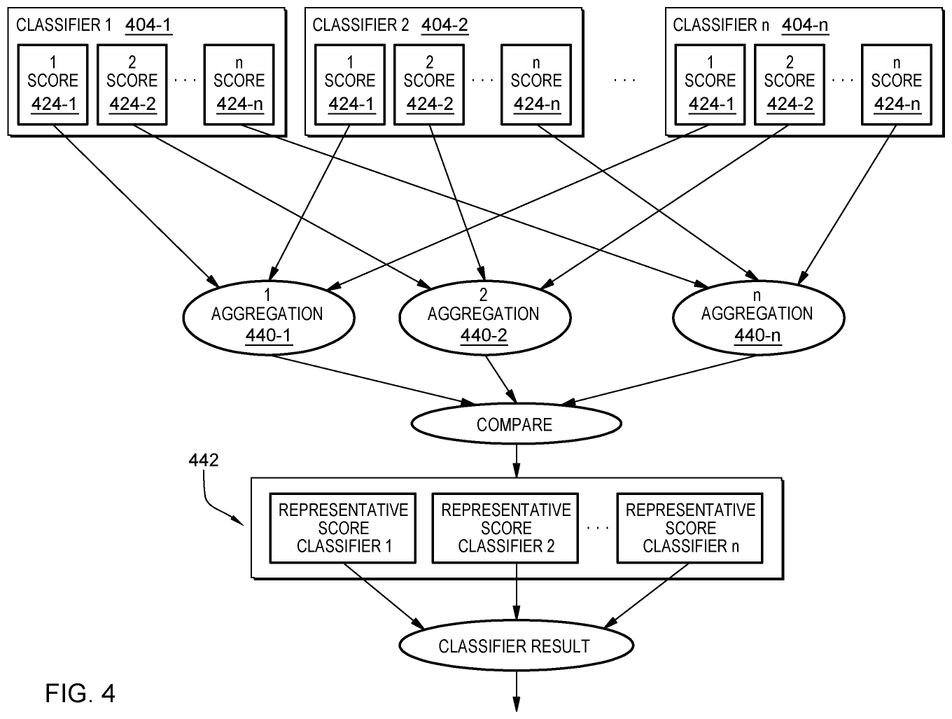

FIG. 4 depicts a visual representation of information received and determined by the representative score selection program 132, in accordance with one embodiment of the present invention. Classifiers 404 in the embodiment of FIG. 4 generate additional classifier scores 424, when compared to the two classifier scores 124 illustrated in FIG. 3. The classifiers 404 in FIG. 4 have no limit to the number of classifier scores 424 that may be generated. The classifier scores 424 may be generated, for example, from parts corresponding to images taken as slices during a medical imaging procedure, or from parts corresponding to financial history data points from a potential loan recipient. Hundreds of images or data points may be taken, with the classifier scores 424 generated by each classifier 404 for each of the images. A first classifier 404-1, therefore, generates a first score 424-1 and a second score 424-2, and a third, fourth, fifth, etc. with the open limit illustrated by an nth score 424-n. A second classifier 404-2 also generates a first score 424-1, a second score 424-2, and an nth score 424-n. As with the embodiment illustrated in FIG. 3, the representative score selection program 132 may receive classifier scores 424 from any number of classifiers 404 illustrated with the open limit nth classifier 404-n.

The representative score selection program 132 may also determine aggregations 440 corresponding to each classifier score 424 generated for a given part. A first aggregation 440-1 is generated for the first scores 424-1. A second aggregation 440-2 is generated for the second scores 424-2. Third, fourth, and fifth aggregations etc. are generated by the representative score selection program 132 as well, with an open limit represented by an nth aggregation 440-n of the nth classifier scores 424-n. The aggregations 440 may be generated similarly to the aggregation 340 in the embodiment illustrated in FIG. 3. For example, the first aggregation 440-1 may include a sum of the first scores 424-1, an average of the first scores 424-1, a median of the first scores 424-1, or other numerical analysis. Furthermore, the aggregations 440 may include weighting of one or more of the classifiers 404.

The representative score selection program 132 also selects representative scores 442 based on comparison of the aggregations 440. The representative scores 442 may be selected as the scores from the highest aggregation 440 or the lowest aggregation 440, or from a selected number of the highest/lowest aggregations 440. For example, if each classifier 404 generates a thousand classifier scores 424, the representative scores 442 may include the top one percent and thus select the classifier scores 424 from the ten highest aggregations 440.

Returning to the method of FIG. 2, once the representative scores 442 are selected, the representative score selection program 132 may determine a classifier result 444 (block 212). The classifier result 444 may be determined using techniques known in the art. For example, the classifier result 444 may be determined by averaging the representative scores 442 and comparing the average to a threshold. If the average of the representative scores 442 is over the threshold, then the classifier result 444 is that a potential condition does exist. For example, the classifier result 444 may include a diagnosis of cancer, a determination that the objects 108 belong to a classification (car, cat, English text, etc.), or other solution to statistical classification problems. The classifier result 444 may also be determined by comparing each of the representative scores 442 to a threshold. This comparison may be used to determine how many of the classifiers 404 agree or disagree that the object belongs in the classification. The procedures and embodiments disclosed herein thus enable a more meaningful classifier result 444 due to the focus provided by the representative scores 442 being more representative than the rest of the classifier scores 424.

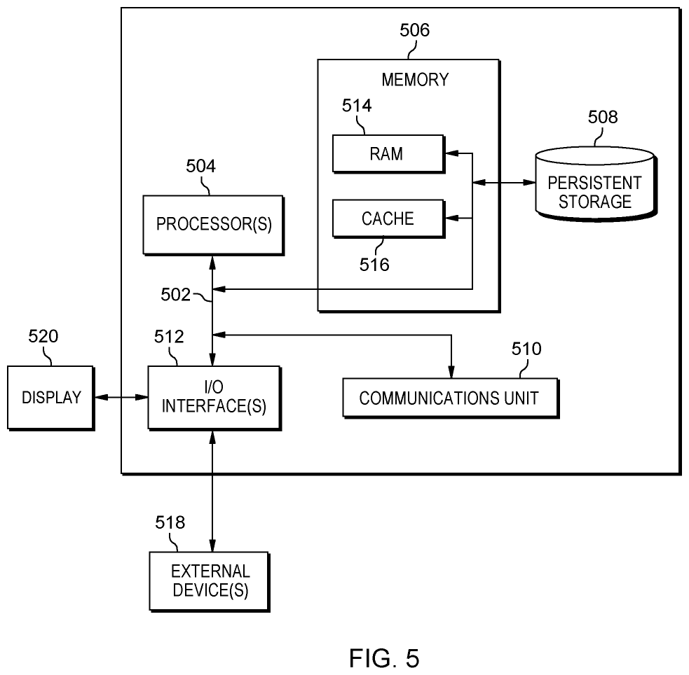

FIG. 5 depicts a block diagram of components of one or more of the object server 102, the classifiers 104, and the representative score selection device 106 in accordance with an illustrative embodiment of the present invention. Each of the object server 102, the classifiers 104, and the representative score selection device 106 may be embodied on a separate device, or each of the object server 102, the classifiers 104, and the representative score selection device 106 may be embodied on the same device having the components shown in FIG. 5. It should be appreciated that FIG. 5 provides only an illustration of one implementation and does not imply any limitations with regard to the environments in which different embodiments may be implemented. Many modifications to the depicted environment may be made.

The object server 102, the classifiers 104, and/or the representative score selection device 106 may include communications fabric 502, which provides communications between RAM 514, cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of computer processor(s) 504 by holding recently accessed data, and data near accessed data, from memory 506.

The classifier algorithm(s) 130 and the representative score selection program 132 may be stored in persistent storage 508 and in memory 506 for execution and/or access by one or more of the respective computer processors 504 via cache 516. In an embodiment, persistent storage 708 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. The classifier algorithms 130 and the representative score selection program 132 may be downloaded to persistent storage 508 through communications unit 510.

I/O interface(s) 512 allows for input and output of data with other devices that may be connected to server computer. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention (e.g., the classifiers 104, 404) can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for selecting representative scores, comprising:
receiving first scores generated by a plurality of object part classifiers classifying a first part of an object;
receiving second scores generated by the plurality of object part classifiers classifying a second part of the object;
determining a first aggregation of the first scores;
determining a second aggregation of the second scores;
selecting the representative scores from the first scores and the second scores based on a comparison between the first aggregation and the second aggregation; and
determining a classifier result based on the representative scores.

2. The method of claim 1, wherein the first part and the second part comprise images captured using a technique selected from the group consisting of digital mammography, magnetic resonance imaging, computed tomography, and digital breast tomosynthesis.

3. The method of claim 1, wherein the first aggregation comprises a sum of the first scores, the second aggregation comprises a sum of the second scores, and selecting the representative scores comprises selecting a larger aggregation selected from the group consisting of: the first aggregation and the second aggregation.

4. The method of claim 1, wherein the first aggregation comprises a percentage of the object part classifiers for which the first score is higher than the second score, and the second aggregation comprises a percentage of the object part classifiers for which the second score is higher than the first score.

5. The method of claim 4, wherein selecting the representative scores comprises:
selecting a larger aggregation from the group consisting of the first aggregation and the second aggregation when the larger aggregation is larger by at least a significance gap; and
selecting a smaller aggregation from the group consisting of the first aggregation and the second aggregation when the larger aggregation is larger by less than the significance gap.

6. The method of claim 1, wherein the first aggregation comprises a median of the first scores, the second aggregation comprises a median of the second scores, and selecting the representative scores comprises selecting a highest median from the group consisting of the first aggregation and the second aggregation.

7. The method of claim 1, comprising
averaging the representative scores; and
comparing the average of the representative scores to a threshold to determine the classifier result.

8. The method of claim 1, comprising comparing each of the representative scores to a threshold to determine the classifier result.

9. A computer program product for selecting representative scores, the computer program product comprising:
one or more computer-readable storage media and program instructions stored on the one or more computer-readable storage media, the program instructions comprising program instructions to:
receive first scores generated by a plurality of object part classifiers classifying a first part of an object;
receive second scores generated by the plurality of object part classifiers classifying a second part of the object;
determine a first aggregation of the first scores;
determine a second aggregation of the second scores;
select the representative scores from the first scores and the second scores based on a comparison between the first aggregation and the second aggregation; and
determine a classifier result based on the representative scores.

10. The computer program product of claim 9, wherein the first part and the second part comprise images captured using a technique selected from the group consisting of digital mammography, magnetic resonance imaging, computed tomography, and digital breast tomosynthesis.

11. The computer program product of claim 9, wherein the first aggregation comprises a sum of the first scores, the second aggregation comprises a sum of the second scores, and the program instructions to select the representative scores comprise selecting a larger aggregation selected from the group consisting of: the first aggregation and the second aggregation.

12. The computer program product of claim 9, wherein the first aggregation comprises a percentage of the object part classifiers for which the first score is higher than the second score, and the second aggregation comprises a percentage of the object part classifiers for which the second score is higher than the first score.

13. The computer program product of claim 9, wherein the program instructions to select the representative scores comprise instructions to:
select a larger aggregation from the group consisting of the first aggregation and the second aggregation when the larger aggregation is larger by at least a significance gap; and
select a smaller aggregation from the group consisting of the first aggregation and the second aggregation when the larger aggregation is larger by less than the significance gap.

14. The computer program product of claim 9, wherein the first aggregation comprises a median of the first scores, the second aggregation comprises a median of the second scores, and selecting the representative scores comprises selecting a highest median from the group consisting of the first aggregation and the second aggregation.

15. The computer program product of claim 9, wherein the program instructions comprise instructions to:
average the representative scores; and
compare the average of the representative scores to a threshold to determine the classifier result.

16. A computer system for selecting representative scores, the computer system comprising:
one or more computer processors, one or more computer-readable storage media, and program instructions stored on the computer-readable storage media for execution by at least one of the one or more processors, the program instructions comprising program instruction to:
receive first scores generated by a plurality of object part classifiers classifying a first part of an object;
receive second scores generated by the plurality of object part classifiers classifying a second part of the object;
determine a first aggregation of the first scores;
determine a second aggregation of the second scores;
select the representative scores from the first scores and the second scores based on a comparison between the first aggregation and the second aggregation; and
determine a classifier result based on the representative scores.

17. The computer system of claim 16, wherein the first aggregation comprises a sum of the first scores, the second aggregation comprises a sum of the second scores, and the program instructions to select the representative scores comprise selecting a larger aggregation selected from the group consisting of: the first aggregation and the second aggregation.

18. The computer system of claim 16, wherein the first aggregation comprises a percentage of the object part classifiers for which the first score is higher than the second score, and the second aggregation comprises a percentage of the object part classifiers for which the second score is higher than the first score.

19. The computer system of claim 16, wherein the program instructions to select the representative scores comprise instructions to:
select a larger aggregation from the group consisting of the first aggregation and the second aggregation when the larger aggregation is larger by at least a significance gap; and
select a smaller aggregation from the group consisting of the first aggregation and the second aggregation when the larger aggregation is larger by less than the significance gap.

20. The system of claim 16, wherein the program instructions comprise instructions to:
average the representative scores; and
compare the average of the representative scores to a threshold to determine the classifier result.
